(19) United States
(12) Patent Application Publication
(10) Pub. No.: US 2014/0257767 A1
(43) Pub. Date: Sep. 11, 2014

(54) PSO-Guided Trust-Tech Methods for Global Unconstrained Optimization

(71) Applicant: BIGWOOD TECHNOLOGY, INC., Ithaca, NY (US)

(72) Inventors: Hsiao-Dong Chiang, Ithaca, NY (US); Yong-Fong Chang, Jinan (CN)

(73) Assignee: BIGWOOD TECHNOLOGY, INC., Ithaca, NY (US)

(21) Appl. No.: 13/791,982

(22) Filed: Mar. 9, 2013

(51) Int. Cl. G06F 17/50

(52) U.S. Cl. CPC G06F 17/5009
USPC 703/2

(57) ABSTRACT

A method determines a global optimum of a system defined by a plurality of nonlinear equations. The method includes applying a heuristic methodology to cluster a plurality of particles into at least one group for the plurality of nonlinear equations. The method also includes selecting a center point and a plurality of top points from the particles in each group and applying a local method starting from the center point and top points for each group to find a local optimum for each group in a tier-by-tier manner. The method further includes applying a TRUST-TECH methodology to each local optimum to find a set of tier-1 optima and identifying a best solution among the local optima and the tier-1 optima as the global optimum. In some embodiments, the heuristic methodology is a particle swarm optimization methodology.

### BACKGROUND OF THE INVENTION

1. Field of the Invention

The invention pertains to the field of nonlinear optimization. More particularly, the invention pertains to methods for solving nonlinear optimization problems.

2. Description of Related Art

Optimization technology has practical applications in almost every branch of science, business and technology. Indeed, a large variety of quantitative issues such as decision, design, operation, planning, and scheduling can be perceived and modeled as either continuous or discrete nonlinear optimization problems. These problems are bounded in practical systems arising in the sciences, engineering, and economics. Typically, the overall performance (or measure) of a system can be described by a multivariate function, called the objective function. According to this generic description, one seeks the best solution of a nonlinear optimization problem, often expressed by a real vector, in the solution space which satisfies all stated feasibility constraints and minimizes (or maximizes) the value of an objective function. The vector, if it exists, is termed the global optimal solution.

For practical applications, the underlying objective functions are often nonlinear and depend on a large number of variables. This makes the task of searching the solution space for the global optimal solution very challenging. The primary challenge is that, in addition to the high dimensionality of the solution space, there are many local optimal solutions in the solution space in which a local optimal solution is optimal in a local region of the solution space, but not the global solution space. The global optimal solution is just one solution and yet both the global optimal solution and local optimal solutions share the same local properties. In general, the number of local optimal solutions is unknown and it can be quite large. Furthermore, the objective function values at the local optimal solutions and the global optimal solution may differ significantly. Hence, there are strong motivations to develop effective methods for finding the global optimal solution.

One popular method for solving nonlinear optimization problems is to use an iterative local improvement search procedure which can be described as follows: start from an initial vector and search for a better solution in its neighborhood. If an improved solution is found, repeat the search procedure using the new solution as the initial point; otherwise, the search procedure will be terminated. Local improvement search methods usually get trapped at local optimal solutions and are unable to escape from them. In fact, a great majority of existing nonlinear optimization methods for solving optimization problems usually produce local optimal solutions but not the global optimal solution.

The drawback of iterative local improvement search methods has motivated the development of more sophisticated local search methods designed to find better solutions via introducing special mechanisms that allow the search process to escape from local optimal solutions. The underlying “escaping” mechanisms use certain search strategies accepting a cost-deteriorating neighborhood to make an escape from a local optimal solution possible. These sophisticated global search methods include simulated annealing, genetic algorithm, Tabu search, evolutionary programming, and particle swarm operator methods. However, these sophisticated global search methods require intensive computational effort and usually cannot find the globally optimal solution.

Particle Swarm Optimization (PSO) is a heuristic evolutionary computation technique developed by Eberhart and Kennedy (“Particle swarm optimization”, Proceedings IEEE International Conference on Neural Networks, Piscataway, N.J., pp. 1942-1948, 1995). This technique is a form of swarm intelligence in which the behavior of a biological social system like a flock of birds is simulated. It is nearly impossible for only one bird to be alive in the nature world independently since the survival ability of one bird is quite limited. If a certain amount of birds form a “swarm”, however, the swarm has good survival ability, which is not a simple superposition of the survival ability of every bird. The basic reason why the swarm has this property is that each individual has the ability to exchange information with each other. This makes the swarm have some especially adapting abilities and properties ability, each individual does not have. In a word, PSO is a population-based and evolutionary computation technique. The main difference between PSO and other population-based methods is that information shaping of all PSO members is beneficial to the evolution.

Particle Swarm Optimization (PSO) methods play an important role in solving nonlinear optimization problems. Significant R&D efforts have been spent on PSOs and several variations of PSOs have been developed. However, PSO has several drawbacks in searching for the global optimal solution. One drawback, which is common to other stochastic search methods, is that PSO is not guaranteed to converge to the global optimum and can easily converge to a local optimum. Another drawback is that PSO is computationally demanding and has slow convergence rates.

The TRansformation Under STability-reTaining Equilibria CHaracterization (TRUST-TECH) methodology is a dynamical method for obtaining a set of local optimal solutions of general optimization problems including the steps of first finding, in a deterministic manner, one local optimal solution starting from an initial point, and then finding another local optimal solution starting from the previously found one until all the local optimal solutions are found, and then finding the global optimal solution from the local optimal points.

Wang and Chiang (“ELITE: Ensemble of Optimal Input-Pruned Neural Networks Using TRUST-TECH”, IEEE Transactions on Neural Networks, Vol. 22, pp. 96-109, 2011) disclose an ensemble of optimal input-pruned neural networks using a TRUST-TECH (ELITE) method for constructing high-quality ensemble through an optimal linear combination of accurate and diverse neural networks.

Lee and Chiang (“A dynamical trajectory-based methodology for systematically computing multiple optimal solutions of general nonlinear programming problems”, IEEE Transactions on Automatic Control, Vol. 49, pp. 888-899, 2004) disclose a dynamical trajectory-based methodology for systematically computing multiple local optimal solutions of general nonlinear programming problems with disconnected feasible components satisfying nonlinear equality/inequality constraints.

Chiang and Chu (“Systematic search method for obtaining multiple local optimal solutions of nonlinear programming problems”, IEEE Transactions on Circuits and Systems I: Fundamental Theory and Applications, Vol. 13, pp. 99-109, 1996) disclose systematic methods to find several local optimal solutions for general nonlinear optimization problems.

All above-mentioned references are hereby incorporated by reference herein.

### SUMMARY OF THE INVENTION

A method determines a global optimum of a system defined by a plurality of nonlinear equations. The method includes applying a heuristic methodology to cluster a plurality of particles into at least one group for the plurality of nonlinear equations. The method also includes selecting a center point and a plurality of top points from the particles in each group and applying a local method starting from the center point and top points for each group to find a local optimum for each group in a tier-by-tier manner. The method further includes applying a TRUST-TECH methodology to each local optimum to find a set of tier-1 optima and identifying a best solution among the local optima and the tier-1 optima as the global optimum. In some embodiments, the heuristic methodology is a particle swarm optimization methodology.

### BRIEF DESCRIPTION OF THE DRAWINGS

FIG. 1 shows three steps involved in a PSO search procedure.

FIG. 2 shows schematically a first stage of a method of the present invention.

FIG. 3 shows schematically an output of a second stage of a method of the present invention.

FIG. 4 shows schematically finding corresponding tier-1 local optimal solutions in a third stage of a method of the present invention.

FIG. 5 shows the behavior of the best particle of Test Function 1.

FIG. 6 shows the behavior of the best particle of Test Function 2.

FIG. 7 shows the behavior of the best particle of Test Function 3.

FIG. 8 shows the behavior of the best particle of Test Function 4.

FIG. 9 shows the behavior of the best particle of Test Function 5.

### DETAILED DESCRIPTION OF THE INVENTION

In some embodiments, to overcome the limitations of PSO issues, the present methodology uses a PSO-guided TRUST-TECH methodology, which is highly efficient and robust to solve global unconstrained optimization problems. The methodology preferably has the following goals in mind:
1) The methodology is able to find high quality local optimal solutions, and possibly (or highly likely) the global optimal solution.
2) The methodology only searches for a subset of the search space that contains high quality local optimal solutions.
3) The methodology quickly obtains a set of the high-quality optimal solutions.
4) The methodology obtains the set of the high-quality optimal solutions in a tier-by-tier manner.
5) It can obtain better solutions than PSO in a shorter computation time.

In some embodiments, the present methods are automated. At least one computation of the present methods is performed by a computer. Preferably all of the computations in the present methods are performed by a computer. A computer, as used herein, may refer to any apparatus capable of automatically carrying out computations base on predetermined instructions in a predetermined code, including, but not limited to, a computer program.

In some embodiments, the present methods are executed by one or more computers following program instructions of a computer program product on at least one computer-readable, tangible storage device. The computer-readable, tangible storage device may be any device readable by a computer within the spirit of the present invention.

The present methods are efficient and robust methods termed herein as PSO-guided TRUST-TECH methods for solving global unconstrained optimization problems. This methodology preferably includes three main stages described herein as Stage I: Exploration and Consensus Stage, Stage II: Guiding Stage, and Stage III: Exploitation Stage.

The premises for the present methodology to find high-quality local optimal solutions preferably include the following:
1) All the particles of the PSO methodology have reached a high level of consensus by forming several groups. Each group contains a number of particles (large or small) that lie close to each other in the search space.
2) Each group of particles reveals that high-quality local optimal solutions, even the global optimal solution, are located in the region ‘covered’ by the particles and are close to the particles.
3) From the high-quality local optimal solutions obtained by the PSO methodology, the TRUST-TECH methodology effectively finds all the tier-1 and tier-2 local optimal solutions located in the covered region of the search space.
4) The set of all the tier-0, tier-1 and tier-2 local optimal solutions obtained by TRUST-TECH methodology contains a set of high-quality local optimal solutions or even the global optimal solution.

The only reliable way to find the global optimal solution of an unconstrained optimization problem is to first find all the high-quality local optimal solutions and then, from them, find the global optimal solution. The TRUST-TECH methodology is a dynamical method for obtaining a set of local optimal solutions of general optimization problems including the steps of first finding, in a deterministic manner, one local optimal solution starting from an initial point, and then finding another local optimal solution starting from the previously found one until all the local optimal solutions are found, and then finding the global optimal solution from the local optimal points. The TRUST-TECH methodology framework is illustrated in solving the following unconstrained nonlinear programming problem.

Without loss of generality, an n-dimensional optimization problem can be formulated:

$$[ 1 ]$$

where C: [symbol] → [symbol] is a function bounded below and possesses only finite local optimal solutions.

A focus of solving this problem is to locate all or multiple local optimal solutions of C(x). The TRUST-TECH methodology solves this optimization problem by first defining a dynamical system:

\dot{x}(t)=−ΔC(x), x ∈ [symbol] [2]

Moreover, the stable equilibrium points (SEPs) in the dynamical system have one-to-one correspondence with local optimal solutions of the optimization problem [1]. Because of this transformation and such a correspondence, we have the following results:

A local optimal solution of the optimization problem [1] corresponds to a stable equilibrium point of the gradient system [2].

The search space of the optimization problem [1] of computing multiple local optimal solutions is then transformed to the union of the stability regions in the defined dynamical system, each of which contains only one distinct SEP.

An SEP can be computed using a trajectory method or using a local method with a trajectory point lying in its stability region as the initial point.

This transformation allows each local optimal solution of the problem [1] to be located via each stable equilibrium point of the gradient system [2].

The task of selecting proper search directions for locating another local optimal solution from a known local optimal solution of the unconstrained optimization problem in an efficient way is very challenging. Starting from a local optimal solution (i.e. a SEP), there are several possible search directions that may be chosen as a subset of dominant eigenvectors of the objective Hessian at the SEP. However, computing Hessian eigenvectors, even dominant ones, is computationally demanding, especially for large-scale problems. Another choice is to use random search directions, but they need to be orthogonal to each other in order to span the search space and to maintain a diverse search. It appears that effective directions in general have a close relationship with the structure of the objective function (and the feasible set for constrained problems). Hence, exploitation of the structure of the objective under study proves fruitful in selecting search directions.

By exploring the TRUST-TECH methodology's capability to escape from local optimal solutions in a systematic and deterministic way, it becomes feasible to locate multiple local optimal solutions in a tier-by-tier manner. As a result, multiple high-quality local optimal solutions are obtainable.

There are several variants of PSO methods to which the present methodology is applicable. As an illustration, the traditional PSO methodology is used in the following presentation. In the initialization phase of PSO, the positions and velocities of all particles are randomly initialized. Fitness value, which is the objective function value, is calculated at each random position. These fitness values are respectively pbests of each particle which implies the optimal fitness of each particle so far. Among these fitness values, the best one is the initial gbest which is the optimal fitness value among all the particles so far. In each step, PSO relies on the exchange of information between particles of the swarm. This process includes updating the velocity of a particle and then its position. The former is accomplished by the following equation:

vᵢ^{k+1}=ωvᵢ^{k}+c₁r₁(p_{ibest}−xᵢ^{k})+c₂r₂(g_{best}−xᵢ^{k}) [3]

where vᵢ^{k} is the velocity of the ith particle at the kth step. xᵢ^{k} denotes the position of the ith particle at the kth step. ω is the inertia weight, which is used for seeking a balance between the exploitation and exploration ability of particles. Typically, these are both set to a value of 2.0. r₁ and r₂ are elements from two uniform random sequences in the range (0,1).

The PSO search procedure preferably consists of three parts and the relationship among them is described in FIG. 1. Part I 10 represents the inertia of a particle itself. Part II 12 represents the next search direction each particle should move, which is its own previous best position. Part III 14 dictates that each particle should move towards the best position of all particles so far.

The new position of each particle is calculated using:

xᵢ^{k+1}=xᵢ^{k}+vᵢ^{k+1} [4]

In order to achieve an update of the velocity of each particle, the new fitness value is preferably calculated at the new position to replace the previous pbest or gbest if a better fitness value is obtained. This procedure is repeated until a stopping criterion is met.

There are some improved PSO methods, such as designing a new mathematical model of PSO by using other methods or combining with different mutation strategies to enhance their search performance. Despite these improvements, PSO based methods still suffer from several disadvantages. For instance, these methods usually do not converge to the global optimum and easily converge to a local optimum, which affects the convergence precision or even causes divergence and calculation failure. Additionally, their computational speed can be very slow. Furthermore, they lack the ability to find the global optimum of large-scale optimization problems as compared to small-scale problems with a similar topological structure.

### PSO-Guided TRUST-TECH Methodology

According to the characteristics of the TRUST-TECH method and the PSO technique mentioned above, the present methods are developed as PSO-guided TRUST-TECH methodologies for solving general nonlinear optimization problems. This methodology preferably includes three stages, Stage I: Exploration and Consensus Stage, Stage II: Guiding Stage, and Stage III: Exploitation Stage.

### Stage I: Exploration and Consensus Stage

PSO methods preferably guide each particle to promising regions that may contain the global optimal solution. However, since each particle has different information regarding the location of the global optimal solution, these particles hold different views of the locations and all the particles may gather at several different regions of the state space. These individual particles start to form groups of particles as they progress. They preferably reach an ‘equilibrium state’ for consensus that meets the following conditions:

1) The number of groups of particles is not changing.

2) The members in each group are not changing.

All of the particles settle down to different locations, which form several different groups in the research space. All the particles do not form only one group. Also, it should be noted that the largest group, i.e. the group containing the greatest number of particles, does not necessarily indicate the region with members of particles that will settle down to the global optimal solution. In some cases, distinct particles with outstanding performance move towards the region that contains the global optimal solution.

The number of particles in each group and the quality of the fitness value that each member possesses do not necessarily reveal information regarding the quality of local optimal solutions lying in the region. Consequently, the region to which each group of particles settles down is preferably exploited by the TRUST-TECH method in a tier-by-tier manner in order to obtain high-quality local optimal solutions. Therefore, all groups are preferably explored to make sure the global optimum is obtained.

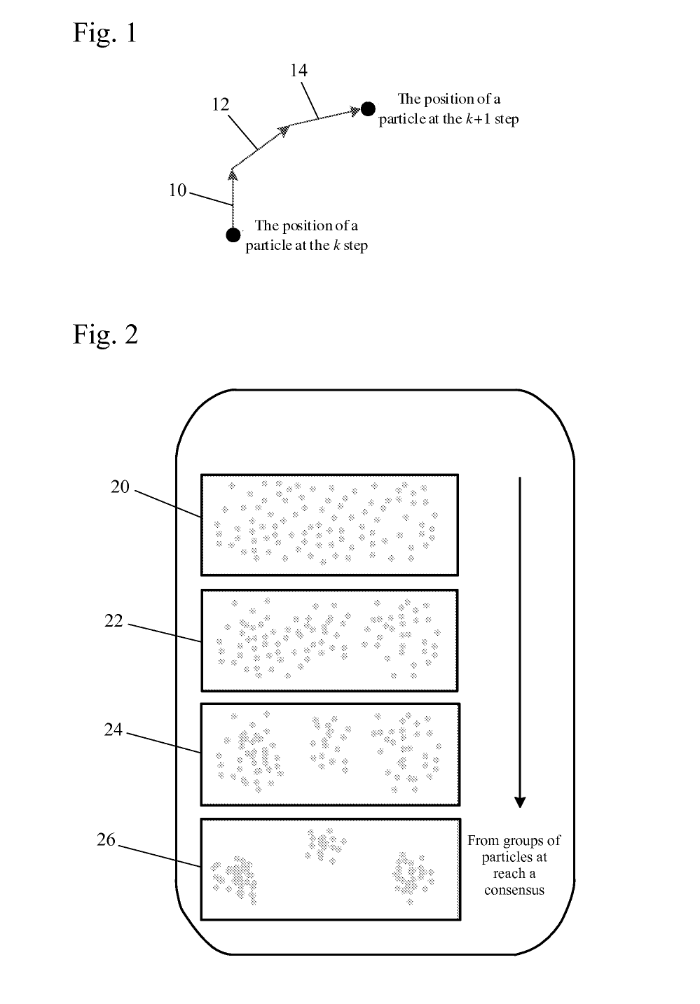

To make the assistance more efficient, Stage I clusters all the particles using effective supervised and unsupervised grouping schemes such as an Iterative Self-Organizing Data Analysis Techniques Algorithm (ISODATA) to identify the groups after certain iterations. It should be noted that ISODATA is an unsupervised classification method, and a user needs to provide threshold values, which are used to determine the groups and their members. In view of the results of clustering, the stopping criterion (i.e. the consensus condition) of Stage I is reached when all the particles have reached a consensus. If not, the PSO continues the exploration stage until the end condition is met. At the beginning of the stage, for example at a first point 20 in FIG. 2. the particles are unclustered. As the stage progresses to a second point 22, a third point 24, and a final point 26, the particles cluster into three groups in the system shown schematically in FIG. 2.

### Stage II: Guiding Stage

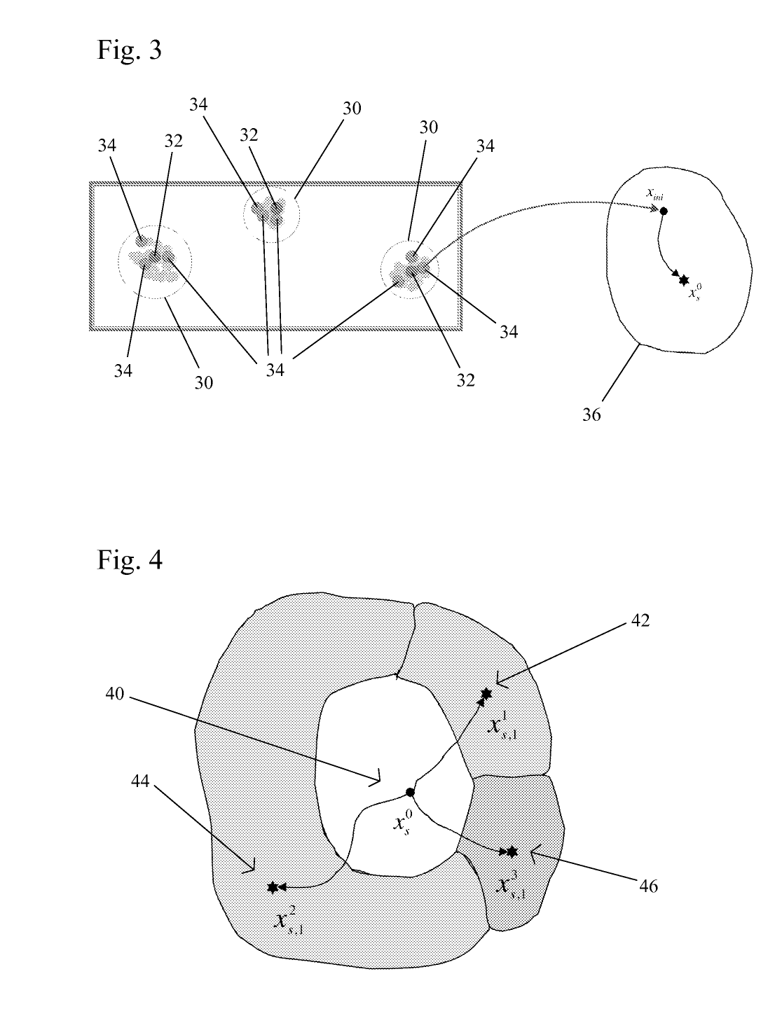

After Stage I, the methodology preferably enters Stage II which is the guiding stage. This stage serves as the interface between the PSO and the TRUST-TECH method. Stage II is shown schematically in FIG. 3. In this stage, the top three particles 34 and the center point 32 in each group 30 are selected and are used as guidance for the TRUST-TECH methodology to exploit the ‘covered’ region for high-quality local optimal solutions and the global optimal solution. The steps of Stage II are preferably as follows:
1) The top three points and the center point in each group are selected as initial points for a local method.
2) Starting from these points, an effective local method is applied to search for corresponding local optimal solutions.

The outputs 36 of this stage are the local optimal solutions obtained from each group. The most number of local optimal solutions from each group equals the number of initial points.

### Stage III: Exploitation Stage

A TRUST-TECH method plays an important role in Stage III, which helps the local optimal method to escape from one local optimal solution and move on toward another local optimal solution. A TRUST-TECH method preferably exploits all of the local optimal solutions in each ‘covered’ region in a tier-by-tier manner.
1) From an obtained local optimal solution of Stage II, the TRUST-TECH methodology intelligently moves away from the local optimal solution and approaches, together with the local method, another local optimal solution in a tier-by-tier manner.
2) After finding the set of tier-1 local optimal solutions, the TRUST-TECH method continues to find the set of tier-2 local optimal solutions, if necessary.

It is interesting to note that the search space of Stage III is the union of the stability region of the seed local optimal solutions from Stage II, the stability region of each tier-one local optimal solution from Stage III, and the stability region of each tier-two local optimal solution from Stage III. The exploitation procedure starts from the local optimal solutions obtained at Stage II located in each group, i.e. the seed local optimal solutions. For each group, there are at most four local optimal solutions obtained at Stage II. All the tier-one local optimal solutions 42, 44, 46 from each local optimal solution 40 are obtained by the TRUST-TECH methodology in Stage III, schematically shown in FIG. 4. Hence, there are at most four sets of tier-one local optimal solutions computed by the TRUST-TECH method for each group. The top few local optimal solutions from all of the tier-one local optimal solutions, or some of tier-two local optimal solutions, are the outputs of this Stage.

Theoretically speaking, the TRUST-TECH methodology may continue to find the set of tier-3 local optimal solutions at the expense of considerable computational efforts. From experience, however, of the set of tier-1 local optimal solutions, there usually exists a very high-quality local optimal solution, if not the global optimal solution. Hence, the exploitation process is terminated after finding all the first-tier local optimal solutions. If necessary, the tier-2 local optimal solutions may be obtained in Stage III.

The TRUST-TECH methodology may search all the local optimal solutions in a tier-by-tier manner and then search the high-quality optimum among them. If the initial point is not close to the high-quality optimal solution, then the task of finding the high-quality optimal solutions may take several tiers of local optimal solution computations. Hence, an important aim of Stage I is to reduce the number of tiers required to be computed at Stage III. All of the particles of the PSO stage are preferably grouped into no more than a few groups of particles, when all the particles have reached a consensus. More preferably, all of the particles of PSO are grouped into no more than three groups of particles. It is likely that local optimal solutions in these regions contain the high-quality optimum.

There is no theoretical proof that the locations of the top few selected local optimal solutions are close to the high-quality optimal solution, however, from experience all of the high-quality optimal solutions were obtained in all numerical studies. Selecting the top-performance particles from each group as initial points in the guiding stage allows the scheme embedded in the Stage III to be effective.

In summary, a three-stage PSO-guided TRUST-TECH methodology preferably proceeds in the following manner:

### 3-Stage PSO-Guided TRUST-TECH Methodology

### Stage I: Exploration and Consensus

Use a PSO or an Improved PSO method to solve the optimization problem. After a certain number of iterations, apply a grouping scheme (e.g. ISODATA) to all the particles to form the groups. In some embodiments, the number of iterations is predetermined. In other embodiments, the number of iterations is based on meeting a predetermined criterion. When the members in each group and the number of groups do not change with further iterations, this implies that all the particles have reached a consensus. Then, the stopping condition is met and Stage I is completed.

### Stage II: Selection and Guiding Stage

Select the top few particles in terms of their objection function value and the center particle from each group. In a preferred embodiment, the top three particles are selected. Starting from each selected particle, apply a local optimization method to find the corresponding local optimal solution. These local optimal solutions are then used as guidance for the TRUST-TECH methodology to search for the corresponding tier-one local optimal solutions during Stage III.

### Stage III: Exploitation Stage

Starting with each obtained (tier-0) local optimal solution, apply the TRUST-TECH methodology to intelligently move away from this local optimal solution and find the corresponding set of tier-1 local optimal solutions. After finding the set of tier-1 local optimal solutions, the TRUST-TECH method continues to find the set of tier-2 local optimal solutions, if necessary. Finally, identify the best local optimal solution among tier-0, tier-1 and tier-2 local optimal solutions.

In order to evaluate the present methodology, several 1000-dimension benchmark functions, listed in Table 1, are used here. The advantages of using this methodology are clearly manifested as illustrated by the results in the following five cases. Stage I uses a traditional PSO. The number of particles of PSO is set to be 30, and the maximum iteration number is set to be 1000.

TABLE 1
The Test Functions

| Function | Range | Dimension |
|---|---|---|
| $F ( x ) = {\sum }_{i = 1}^{n} ( exp ( {x}_{i} ) - {ix}_{i} )$ | [−500, 500] | 1000 |
| $F ( x ) = {\sum }_{i = 1}^{n} ( exp ( {x}_{i} ) - \frac{{x}_{i}}{i} )$ | [−500, 500] | 1000 |
| $F ( x ) = {\sum }_{i = 1}^{n} ( exp ( {x}_{i} ) - i sin ( {x}_{i} ) )$ | [−500, 500] | 1000 |
| $F ( x ) = {\sum }_{i = 1}^{n} ( exp ( {x}_{i} ) - \sqrt{i} {x}_{i} )$ | [−500, 500] | 1000 |
| $F ( x ) = {\sum }_{i = 1}^{n} \frac{i}{10} ( {e}^{{x}_{i}} - {x}_{i} )$ | [−500, 500] | 1000 |

Stage I provides the ‘covered’ search region and the locations of optimal solutions after the particles have reached a consensus, while Stage II provides the corresponding tier-0 local optimal solutions from the three best particles and the center point of each region. Stage III searches for the tier-1 or tier-2 local optimal solutions starting from these tier-0 local optimal solutions and obtains a set of high-quality optimal solutions, preferably including the global optimal solution.

The evaluation results are shown in Table 2 through Table 7. In these tables, the first column lists the iteration number of PSO when all particles have reached a consensus. The second column lists the results of Stage I and Stage II and includes the number of particles in each group, the index of the three best particles, and the centers and their objective function values. The third column lists the results of Stage III which are the high-quality local optimal solutions starting from the result of Stage II, which is obtained during the first-tier search process. The fourth column lists the degree of improvement from solutions obtained by the PSO method and by the present 3-stage methodology.

### Test Function 1

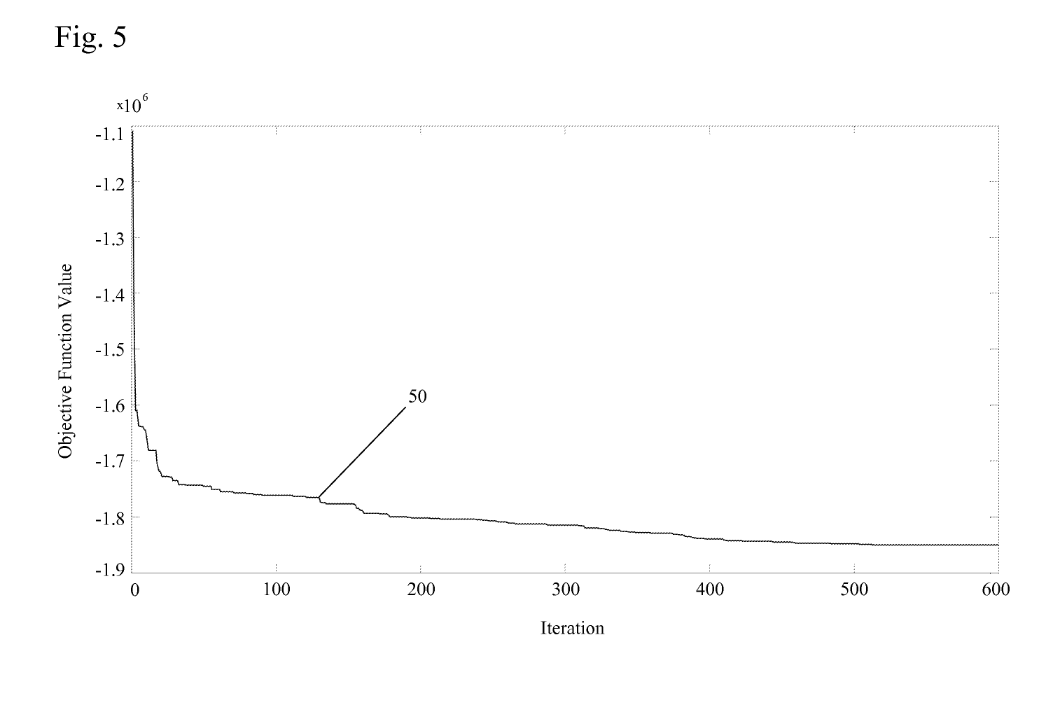

After 600 iterations of Stage I, the particles reached an equilibrium state of consensus in which the number of groups of particles and the members in each group did not change upon further iterations. FIG. 5 shows the behavior of the objective function value 50 of the best particle.

At Stage II, according to their positions in the search space, all particles were congregated into three groups, and the regions they cover may contain the global optimal solution. The three best particles and the center point of each group and each region were subjected to a local optimization method. Starting from these points, the local optimal method obtained a few local optimal solutions in each group, which formed the tier-0 local optimal solution in each group.

At Stage III, the TRUST-TECH method led the local method to exploit all the local optimal solutions in each region in a tier-by-tier manner. The best top local optimal solutions were then identified. At this stage, the best optimal solution, whose value is −2.706832e+06, was obtained, as shown in Table 2. It should be noted that the average degree of improvement over the PSO result in each group is 45.642%.

TABLE 2
Result of Test Function 1

| | Stage I and II | | | | | | |
|---|---|---|---|---|---|---|---|
| | | | The index of the | | | | |
| | | Number | three best | | | Stage III | |
| Iterations | | of | particles in this | | Based Results | High-quality | Improvement |
| of PSO | Cluster | Particles | group(1th~3th) | | from PSO | optimum | (%) |
| 600 | 1 | 24 | Center | | −1.858580e+06 | −2.706832e+06 | 45.6398 |
| | | | 1 | 22 | −1.858579e+06 | −2.706832e+06 | 45.6399 |
| | | | 2 | 19 | −1.858579e+06 | −2.706832e+06 | 45.6399 |
| | | | 3 | 17 | −1.858578e+06 | −2.706832e+06 | 45.6399 |
| | 2 | 2 | Center | | −1.858777e+06 | −2,706832e+06 | 45.6244 |
| | | | 1 | 23 | −1.858913e+06 | −2.706832e+06 | 45.6137 |
| | | | 2 | 14 | −1.858203e+06 | −2.706832e+06 | 45.6693 |
| | 3 | 4 | Center | | −1.858235e+06 | −2.706832e+06 | 45.6668 |
| | | | 1 | 13 | −1.858373e+06 | −2.706832e+06 | 45.656 |
| | | | 2 | 27 | −1 .858101e+06 | −2.706832e+06 | 45.6773 |
| | | | 3 | 18 | −1.858814e+06 | −2.706832e+06 | 45.6215 |

Test Function 2

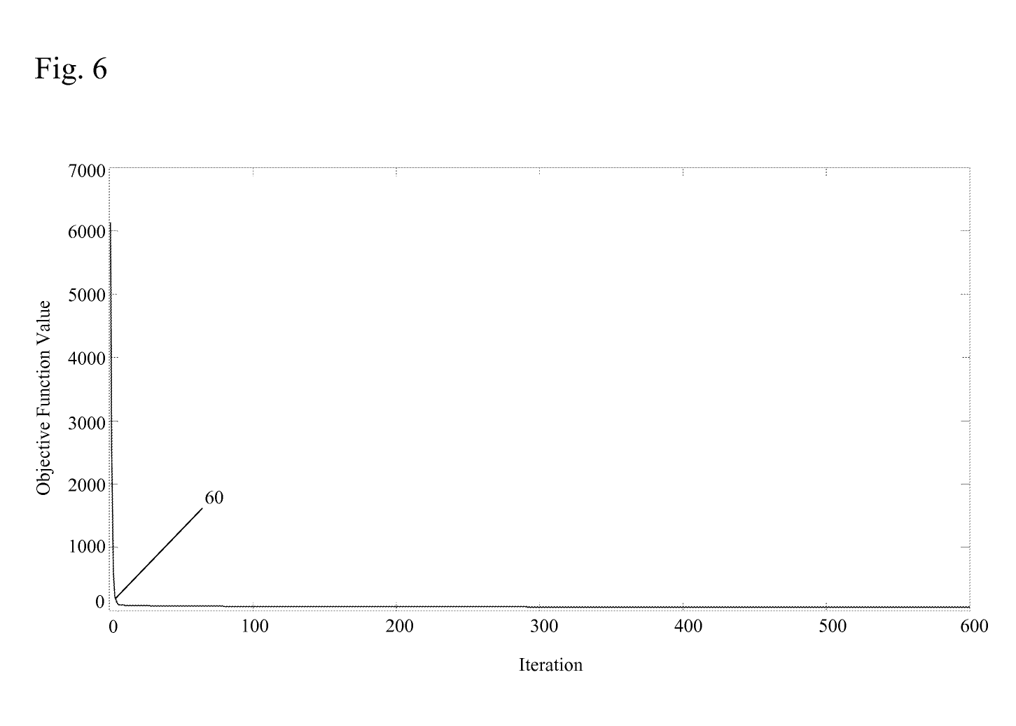

After 600 iterations of Stage I, the particles reached an equilibrium state of consensus in which the number of groups of particles and the members in each group did not change upon further iterations. FIG. 6 shows the behavior of the objective function value 60 of the best particle.

At Stage II, according to their positions in the search space, all particles were congregated into three groups, and the regions they cover may contain the global optimal solution. The three best particles and the center point of each group and each region were subjected to a local optimization method. Starting from these points, the local optimal method obtained a few local optimal solutions in each group, which formed the tier-0 local optimal solution in each group.

At Stage III, the TRUST-TECH method led the local method to exploit all the local optimal solutions in each region in a tier-by-tier manner. The best top local optimal solutions were then identified. At this stage, the best optimal solution, whose value is 3.127465e+01, was obtained, as shown in Table 3. It should be noted that the average degree of improvement over the PSO result in each group is 46.3598%.

TABLE 3
Result of Test Function 2

| | Stage I and II | | | | | | |
|---|---|---|---|---|---|---|---|
| | | | The index of the | | | | |
| | | Number | three best | | | Stage III | |
| Iterations | | of | particles in this | | Based Results | High-quality | Stage I |
| of PSO | Cluster | Particles | group(1th~3th) | | from PSO | optimum | and II |
| 600 | 1 | 8 | Center | | 5.822376e+01 | 3.127465e+01 | 46.28542 |
| | | | 1 | 20 | 5.821780e+01 | 3.127465e+01 | 46.27992 |
| | | | 2 | 25 | 5.822220e+01 | 3.127465e+01 | 46.28398 |
| | | | 3 | 11 | 5.822293e+01 | 3.127465e+01 | 46.28465 |
| | 2 | 20 | Center | | 5.821929e+01 | 3.127465e+01 | 46.28129 |
| | | | 1 | 13 | 5.821392e+01 | 3.127465e+01 | 46.27634 |
| | | | 2 | 29 | 5.821613e+01 | 3.127465e+01 | 46.27838 |
| | | | 3 | 16 | 5.821657e+01 | 3.127465e+01 | 46.27878 |
| | 3 | 2 | Center | | 5.849950e+01 | 3.127465e+01 | 46.5386 |
| | | | 1 | 9 | 5.854223e+01 | 3.127465e+01 | 46.57762 |
| | | | 2 | 23 | 5.855931e+01 | 3.127465e+01 | 46.59321 |

Test Function 3

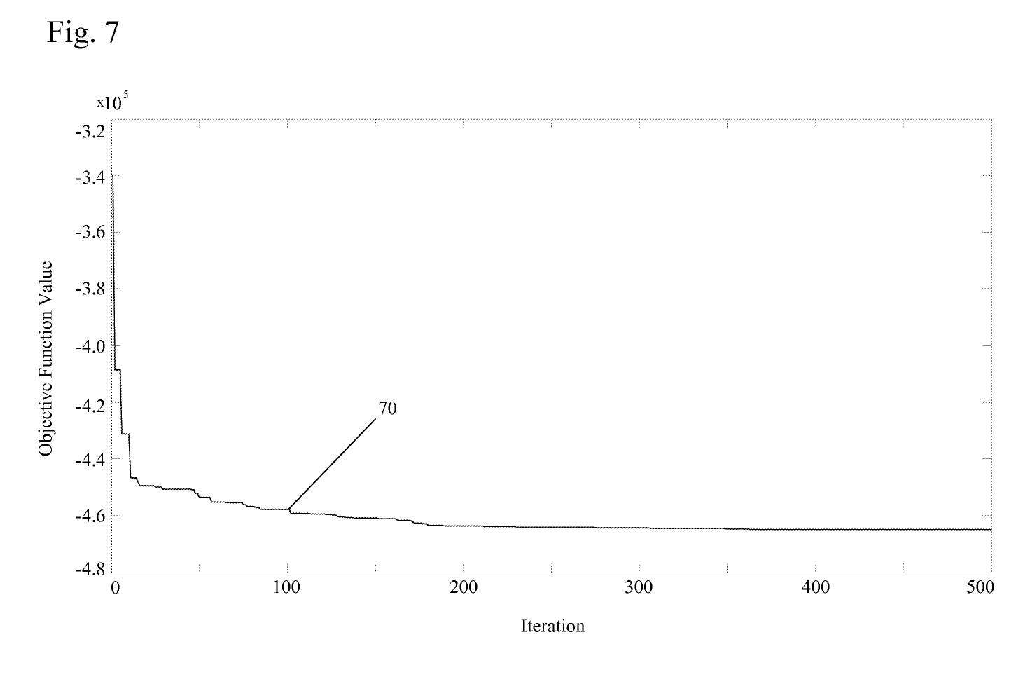

After 500 iterations of Stage I, the particles reached an equilibrium state of consensus in which the number of groups of particles and the members in each group did not change upon further iterations. FIG. 7 shows the behavior of the objective function value 70 of the best particle.

At Stage II, according to their positions in the search space, all particles were congregated into three groups, and the regions they cover may contain the global optimal solution. The three best particles and the center point of each group and each region were subjected to a local optimization method. Starting from these points, the local optimal method obtained a few local optimal solutions in each group, which formed the tier-0 local optimal solution in each group.

At Stage III, the TRUST-TECH method led the local method to exploit all the local optimal solutions in each region in a tier-by-tier manner. The best top local optimal solutions were then identified. At this stage, the best optimal solution, whose value is −4.957525e+05, was obtained, as shown in Table 4. It should be noted that the average degree of improvement over the PSO result in each group is 7.948%. The largest improvement is 16.2816%.

TABLE 4
Result of Test Function 3

| | Stage I and II | | | | | | |
|---|---|---|---|---|---|---|---|
| | | | The index of the | | | | |
| | | Number | three best | | | Stage III | |
| Iterations | | of | particles in this | | Based Results | High-quality | Improvement |
| of PSO | Cluster | Particles | group(1th~3th) | | from PSO | optimum | (%) |
| 500 | 1 | 29 | center | | −4.682826e+05 | −4.957525e+05 | 5.86609 |
| | | | 1 | 30 | −4.682900e+05 | −4.957525e+05 | 5.86442 |
| | | | 2 | 8 | −4.682900e+05 | −4.957525e+05 | 5.86442 |
| | | | 3 | 18 | −4.682900e+05 | −4.957525e+05 | 5.86442 |

| | | | | | |
|---|---|---|---|---|---|
| 2 | 1 | 14 | −4.263377e+05 | −4.957525e+05 | 16.2816 |

Test Function 4

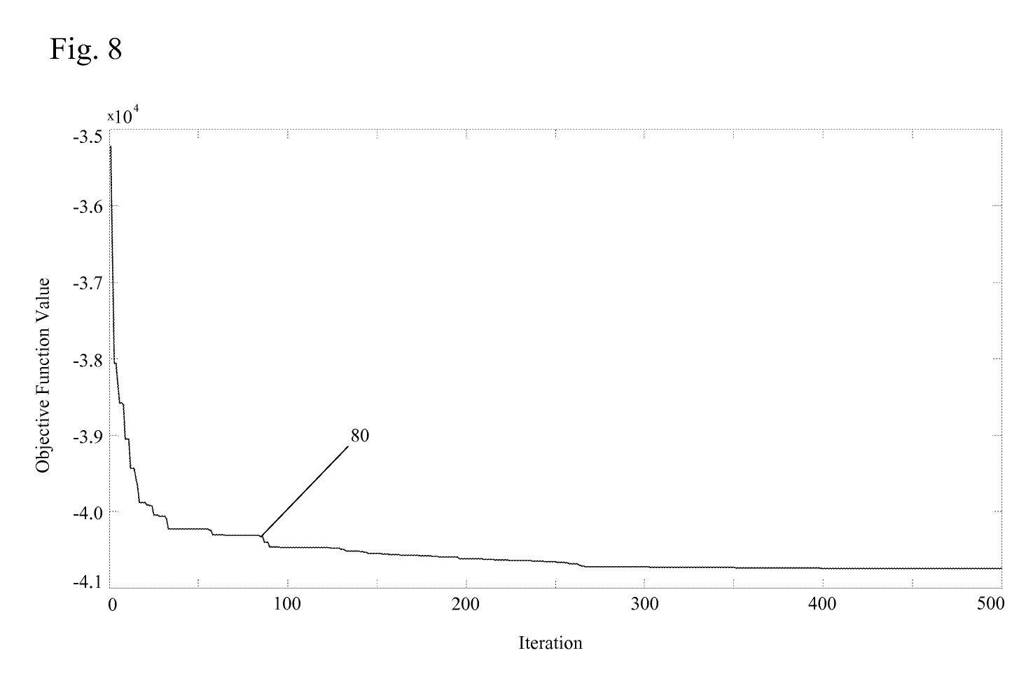

After 500 iterations of Stage I, the particles reached an equilibrium state of consensus in which the number of groups of particles and the members in each group did not change upon further iterations. FIG. 8 shows the behavior of the objective function value 80 of the best particle.

At Stage II, according to their positions in the search space, all particles were congregated into three groups, and the regions they cover may contain the global optimal solution. The three best particles and the center point of each group and each region were subjected to a local optimization method. Starting from these points, the local optimal method obtained a few local optimal solutions in each group, which formed the tier-0 local optimal solution in each group.

At Stage III, the TRUST-TECH method led the local method to exploit all the local optimal solutions lying within each region in a tier-by-tier manner. The best top local optimal solutions were then identified. At this stage, the best optimal solution, whose value is −4.474419e+04, was obtained, as shown in Table 5. It should be noted that the average degree of improvement over the PSO result in each group is 11.163%.

TABLE 5
Result of Test Function 4

| | Stage I and II | | | | | | |
|---|---|---|---|---|---|---|---|
| | | | The index of the | | | | |
| | | Number | three best | | | Stage III | |
| Iterations | | of | particles in this | | Based Results | High-quality | Improvement |
| of PSO | Cluster | Particles | group(1th~3th) | | from PSO | optimum | (%) |
| 500 | 1 | 26 | Center | | −4.041039e+04 | −4.474419e+04 | 10.7245 |
| | | | 1 | 13 | −4.041047e+04 | −4.474419e+04 | 10.7243 |
| | | | 2 | 19 | −4.041043e+04 | −4.474419e+04 | 10.7244 |
| | | | 3 | 11 | −4.041043e+04 | −4.474419e+04 | 10.7244 |
| | 2 | 2 | Center | | −4.025811e+04 | −4.474419e+04 | 11.1433 |
| | | | 1 | 22 | −4.024887e+04 | −4.474419e+04 | 11.1688 |
| | | | 2 | 26 | −4.020270e+04 | −4.474419e+04 | 11.2965 |
| | 3 | 2 | Center | | −4.006762e+04 | −4.474419e+04 | 11.6717 |
| | | | 1 | 12 | −4.010204e+04 | −4.474419e+04 | 11.5758 |
| | | | 2 | 8 | −3.999333e+04 | −4.474419e+04 | 11.8791 |

### Test Function 5

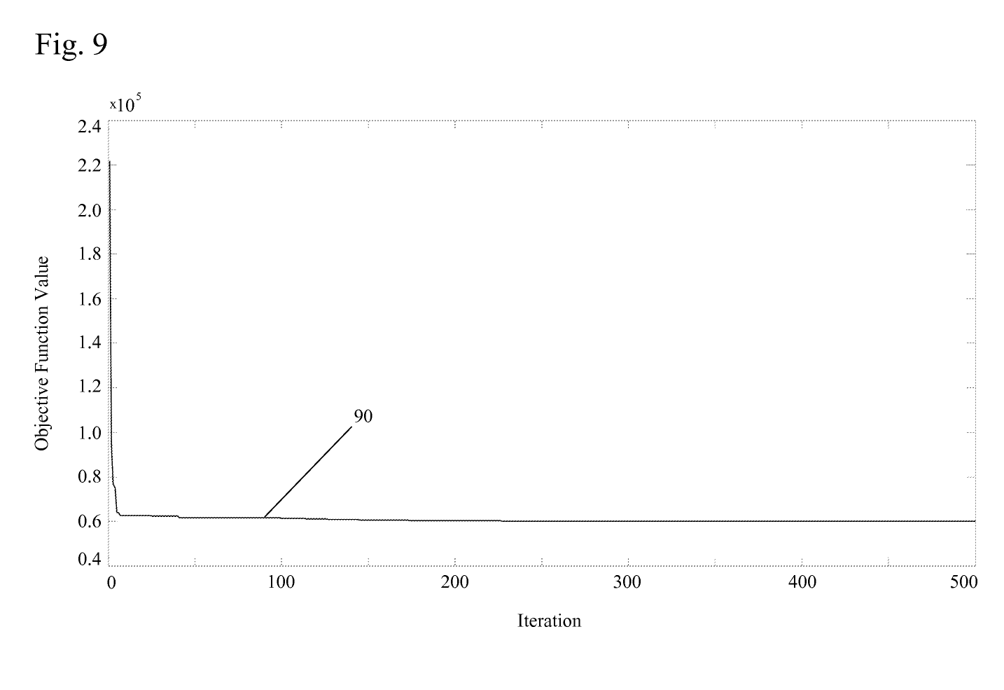

After 500 iterations of Stage I, the particles reached an equilibrium state of consensus in which the number of groups of particles and the members in each group did not change upon further iterations. FIG. 9 shows the behavior of the objective function value 90 of the best particle.

At Stage II, according to their positions in the search space, all particles were congregated into three groups, and the regions they cover may contain the global optimal solution. The three best particles and the center point of each group and each region were subjected to a local optimization method. Starting from these points, the local optimal method obtained a few local optimal solutions in each group, which formed the tier-0 local optimal solution in each group.

At Stage III, the TRUST-TECH method led the local method to exploit all the local optimal solutions in each region in a tier-by-tier manner. The best top local optimal solutions were then identified. At this stage, the best optimal solution, whose value is 5.005000e+04, was obtained, as shown in Table 6. It should be noted that the average degree of improvement over the PSO result in each group is 25.97%. The largest improvement is 71.12%.

TABLE 6
Result of Test Function 5

| | Stage I and II | | | | | | |
|---|---|---|---|---|---|---|---|
| | | | The index of the | | | | |
| | | Number | three best | | | Stage III | |
| Iterations | | of | particles in this | | Based Results | High-quality | Improvement |
| of PSO | Cluster | Particles | group(1th~3th) | | from PSO | optimum | (%) |
| 500 | 1 | 28 | center | | 5.941466e+04 | 5.005000e+04 | 15.76153 |
| | | | 1 | 13 | 5.939347e+04 | 5.005000e+04 | 15.73148 |
| | | | 2 | 4 | 5.939382e+04 | 5.005000e+04 | 11.24914 |
| | | | 3 | 30 | 5.939391e+04 | 5.005000e+04 | 15.7321 |

| | | | | | |
|---|---|---|---|---|---|
| 2 | 1 | 16 | 1.738620e+05 | 5.005000e+04 | 71.11711 |
| 3 | 1 | 9 | 6.950502e+04 | 5.005000e+04 | 27.9907 |

As can be seen from these figures, the behavior of best particle objective function value does not sharply decline after a certain number of iterations. This means that all particles have reached a consensus at which the number of groups of particles and the members in each group do not change upon further iterations.

In order to further compare the performance of the present methodology to a PSO method, the five testing functions were solved by the PSO for a total of 20,000 iterations and the results are shown in Table 7. It can be easily noted that the present methodology outperforms the PSO with 20,000 iterations for solving general high dimensional optimization problems. The present methodology obtains better local optimal solutions than the PSO with much shorter computation time. The present PSO-guided TRUST-TECH methodology significant improves the performance of PSO in solving large-scale optimization problems.

TABLE 7
Comparison of Present Method and PSO after 20000 Iterations

| Function | Present Method | PSO after 20000 | Improvement |
|---|---|---|---|
| Test Function 1 | −2.706832e+06 | −2.330546e+06 | 16.14583% |
| Test Function 2 | 3.127465e+01 | 3.740849e+01 | 16.3969% |
| Test Function 3 | −4.957525e+05 | −4.757604e+05 | 4.202136% |
| Test Function 4 | −4.474419e+04 | −4.102865e+04 | 9.055965% |
| Test Function 5 | 5.005000e+04 | 5.097050e+04 | 1.80595% |

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of determining a global optimum of a system defined by a plurality of nonlinear equations, the method comprising the steps of:
a) a computer applying a heuristic methodology to cluster a plurality of particles into at least one group;
b) the computer selecting a center point and a plurality of top points from the particles in each group;
c) the computer applying a local method starting from the center point and top points for each group to find a local optimum for each group in a tier-by-tier manner;
d) the computer applying a TRUST-TECH methodology to each local optimum to find a set of tier-1 optima; and
e) the computer determining a best solution among the local optima and the tier-1 optima and identifying the best solution as the global optimum.

2. The method of claim 1 further comprising the steps of:
f) the computer applying the TRUST-TECH methodology to each tier-1 optimum to find a set of tier-2 optima; and
g) the computer re-determining the best solution among the local optima, the tier-1 optima, and the tier-2 optima and re-identifying the best solution as the global optimum.

3. The method of claim 2 further comprising the steps of:
h) the computer applying the TRUST-TECH methodology to each tier-2 optimum to find a set of tier-3 optima; and
i) the computer re-determining the best solution among the local optima, the tier-1 optima, the tier-2 optima, and the tier-3 optima and re-identifying the best solution as the global optimum.

4. The method of claim 1, wherein the plurality of top points consists of a first top point, a second top point, and a third top point.

5. The method of claim 1, wherein the at least one group consists of no more than three groups.

6. The method of claim 1, wherein step a) comprises the substep of the computer iteratively applying the heuristic methodology until the number of groups is unchanged and no particles are moving between groups in successive iterations.

7. The method of claim 1, wherein step a) comprises the substep of the computer applying a grouping scheme to the particles to determine the at least one group.

8. The method of claim 1, wherein in step b), the top points are selected based on the objection function values of the points.

9. The method of claim 1 further comprising the step of the computer generating the plurality of particles, each particle having a randomly generated position and a randomly generated velocity, prior to step a).

10. The method of claim 1, wherein the heuristic methodology is a particle swarm optimization methodology.

11. The method of claim 1, wherein the heuristic methodology is an improved particle swarm optimization methodology.

12. A computer program product for determining a global optimum of a system defined by a plurality of nonlinear equations, the computer program product comprising:
at least one computer-readable, tangible storage device;
program instructions, stored on the at least one computer-readable, tangible storage device, to apply a heuristic methodology to cluster a plurality of particles into at least one group;
program instructions, stored on the at least one computer-readable, tangible storage device, to select a center point and a plurality of top points from the particles in each group;
program instructions, stored on the at least one computer-readable, tangible storage device, to apply a local method starting from the center point and top points for each group to find a local optimum for each group in a tier-by-tier manner;
program instructions, stored on the at least one computer-readable, tangible storage device, to apply a TRUST-TECH methodology to each local optimum to find a set of tier-1 optima; and
program instructions, stored on the at least one computer-readable, tangible storage device, to determine a best solution among the local optima and the tier-1 optima and to identify the best solution as the global optimum.

13. The computer program product of claim 12 further comprising:
program instructions, stored on the at least one computer-readable, tangible storage device, to apply the TRUST-TECH methodology to each tier-1 optimum to find a set of tier-2 optima; and
program instructions, stored on the at least one computer-readable, tangible storage device, to re-determine the best solution among the local optima, the tier-1 optima, and the tier-2 optima and to re-identify the best solution as the global optimum.

14. The computer program product of claim 13 further comprising:
program instructions, stored on the at least one computer-readable, tangible storage device, to apply the TRUST-TECH methodology to each tier-2 optimum to find a set of tier-3 optima; and
program instructions, stored on the at least one computer-readable, tangible storage device, to re-determine the best solution among the local optima, the tier-1 optima, the tier-2 optima, and the tier-3 optima and re-identify the best solution as the global optimum.

15. The computer program product of claim 12, wherein the top points are selected based on the objection function values of the points.

16. The computer program product of claim 12 further comprising program instructions, stored on the at least one computer-readable, tangible storage device, to generate the plurality of particles, each particle having a randomly generated position and a randomly generated velocity.

17. The computer program product of claim 12, wherein the heuristic methodology is a particle swarm optimization methodology.
